(19) United States
(12) Patent Application Publication
(10) Pub. No.: US 2016/0324115 A1
(43) Pub. Date: Nov. 10, 2016

(54) LITTER SCOOP SYSTEM

(71) Applicant: Jennifer Bridges, Midland, MI (US)

(72) Inventor: Jennifer Bridges, Midland, MI (US)

(21) Appl. No.: 14/705,009

(22) Filed: May 6, 2015

(51) Int. Cl. A01K 1/01

(52) U.S. Cl. CPC A01K 1/0114

(57) ABSTRACT

An animal waste scooper system that improves the collection and control of cleaning after pets.

### BACKGROUND OF THE INVENTION

The present invention is an animal waste scooper system that improves the collection and control of cleaning after pets. The use of tools in conjunction litter boxes to collected animal waste is not new to the art, but the animal waste scooper system is.

The problem is, people hate to clean the cat litter box for a multitude of reasons. To effectively clean a litter box it is required that the litter be scooped continuously until all waste has been removed from the litter. Another reason is that cleaning the animal waste from the litter box is a task that is less than enjoyable. Making it a task that inevitably gets put off until it absolutely has to be performed. There are also significant amounts of ammonia and bacteria present that can get onto the skin of the operator and can also be breathed in, possibly resulting in health issues. Yet another reason the task of cleaning the litter box is disliked is that it requires that the operator squat or get on their knees to perform the operation of cleaning. This again puts the desire to perform the task on a very low priority as it can lead to knee or back pain.

All of this results in a situation where the litter box is not cleaned in a timely and orderly fashion. As a result the pets do not live in the highest state of hygiene that they could. By nature cats are extremely clean animals so they suffer from a lower standard of hygiene.

It has been discovered that the animal waste scooper system eliminates all of the drawbacks of current litter systems by the 3 components of the system which are the scoop, the frame bagging system and the step mat.

First, the scoop is radically different than others because of its size. It is about the size of a small snow shovel that fits the size of the litter box, meaning one or two passes with the scoop will remove all of the waste from the litter box.

Secondly, the frame bagging system is positioned at the opposite end of the litter box so as the operator scoops the waste from the litter box they simply empty it into bag without leaving the confines of the litter box, thus reducing spillage and eliminating mess.

Finally, the step mat that the litter box sets on is designed to hold the box in place and prevent sliding while the scooping motion is being performed. The step mat is also designed to be a base for the frame bagging system. The step mat will also catch litter that the cat will track out of the box. The animal waste scoop system accomplishes all of the goals necessary for making the task easier for the operator and a healthier situation for the cat.

U.S. Pat. No. 5,855,186 entitled “Sanitization system for cat litter box”, issued to Larsen on Jan. 5, 1999 teaches a sanitization system for cat litter boxes which is composed of a scoop device for straining cat litter wherein the scoop device has a handle member from which a scoop region extends axially. A predetermined distance axially from the scoop region, a containment member extends laterally of the handle where the containment member has a multiplicity of venting orifices extending therethrough. A fluid reservoir is removably attached to the cat litter box. The fluid reservoir is defined by a housing having an open end and a cavity chamber where the cavity chamber is so dimensioned and constructed to be in fluid communication with the open end to permit the passage of fluid through the open end. A deodorizing and disinfectant fluid is carried in the reservoir. To seal the reservoir, the dimension of the open end of the reservoir and of the containment member are substantially identical such that when the scoop is stored in the reservoir the containment member will seal it and permit deodorizing vapors to escape through the orifices. The system also includes a plastic bag holder which is defined by a frame having a multiplicity of suspended members from which the plastic bags may be suspended. This prior art is limited, in that, the frame that the bags are suspended from is only for bag storage and not to have the bags ready for use. It also does not have the scoop designed to fit the entire size of the box requiring a multiplicity of passes with the scoop, thus wasting time. It has been discovered that the present invention overcomes all the drawbacks of this particular piece of prior art.

### THE INVENTION

The present invention is an animal waste scooper system. The animal waste scooper system comprises in combination a scoop that has a basket-like structure with a bottom, a back, having a receptacle formed therein, and two sides. The bottom, back, and sides have a plurality of apertures formed therethrough.

There is a shaft that has a near end and a distal end. The near end is insertable and fixed in the receptacle in the back. The distal end terminates in a handle grip.

There is a litter box and a step mat, said litter box integrally formed with the step mat. The animal waste scooper system has a frame bagging system that comprises, a vertical wall attached to a top surface of the step mat. The vertical wall has a distal end, said distal end comprised of an open frame. The open frame fixed to the distal end of the vertical wall at a convenient angle.

### BRIEF DESCRIPTION OF THE DRAWINGS

FIG. 1 shows the animal waste scooper system from the top.

FIG. 2 shows the scooper of the animal waste scooper system from the top.

FIG. 3 shows the scooper of the animal waste scooper system.

FIG. 4 shows the scooper of the animal waste scooper system from the side.

FIG. 5 shows the step mat of the animal waste scooper system.

FIG. 6 shows the animal waste scooper system from the side.

FIG. 7 shows the separation of the vertical wall 34 from the frame bag holder 40.

### DETAILED DESCRIPTION OF THE DRAWINGS

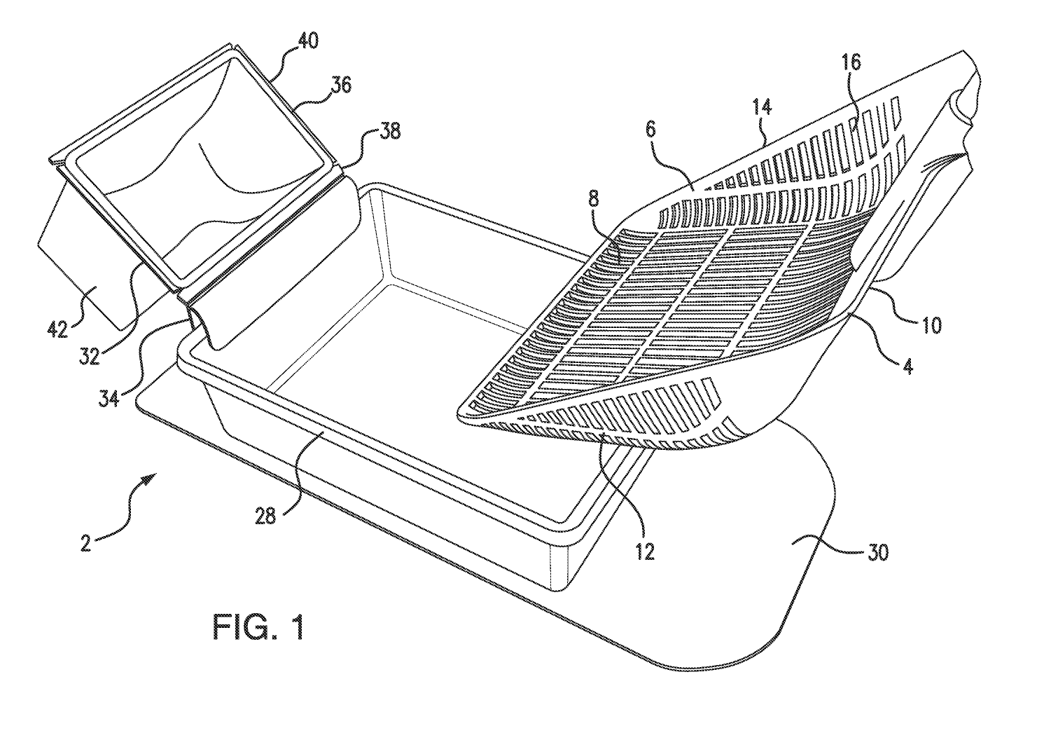

FIG. 1 shows the animal waste scooper system 2 from the top. The animal waste scooper system 2 has a scoop 4 that has a basket like structure 6. This basket like structure 6 has a bottom 8, a back 10, a first side 12 and a second side 14. Also shown are the apertures 16 therethrough.

This Figure also shows the litter box 28, the step mat 30 and the bagging frame 32. This bagging frame 32 has a vertical wall 34 and a distal end 38 that supports an open frame 40 for holding the bag for waste disposal.

It is clear from this Figure that the scooper 4 is large enough to clean all the litter in the litter box 28 with one pass. It has been discovered that the ability to clean the entire litter box 28 with one or two passes saves time.

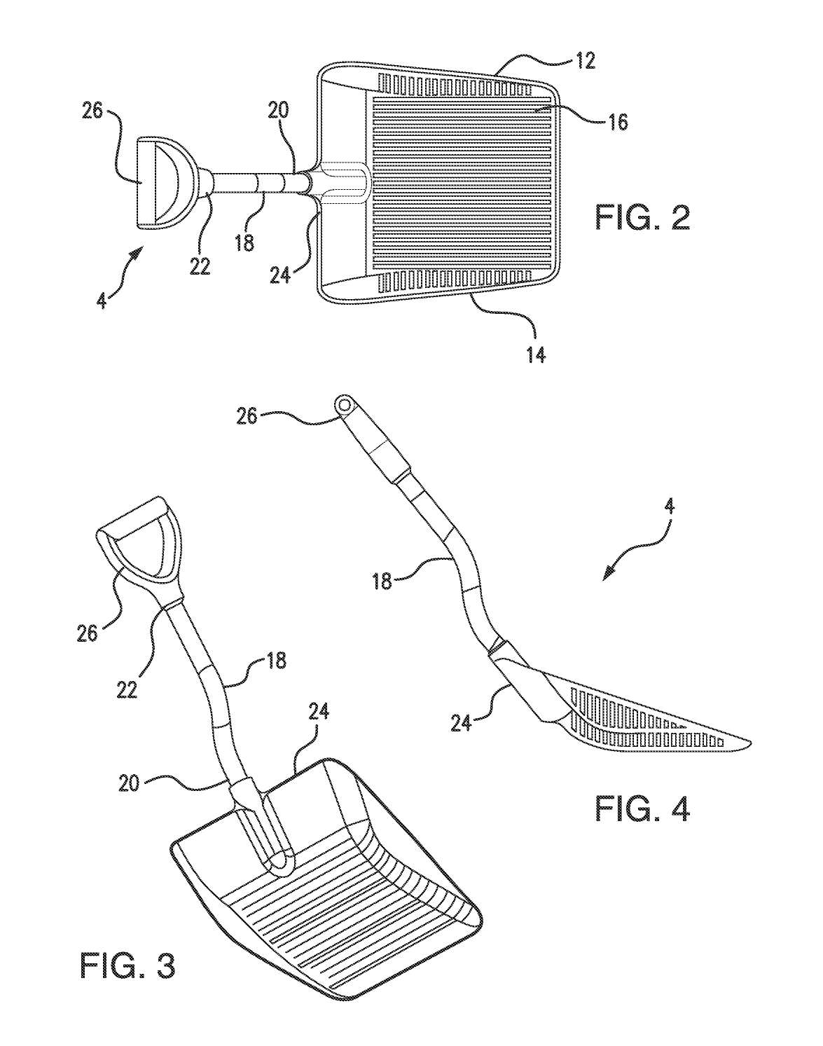

FIG. 2 shows the scooper 4 of the animal waste scooper system 2 from the top. The scooper 4 has a handle 18. This handle can be straight or have an ergonomically curved handle 18 as is shown herein. The scoop 3 has a first side 2 and a second side 14. Also the handle 18 has apertures 16 therethrough. The apertures are designed to allow the loose litter to pass through while the solid waste is retained within the scooper 4. The solid waste is then transferred into the bag 42. The handle 18 has a near end 20 that is received by the scooper receptacle 24. There is also a distal end 22 that has a D handle 26 to hold the scooper 4.

FIG. 3 shows the scooper 4 of the animal waste scooper system 2. This Figure shows the D handle 26 of the distal end 22 much clearer as with the scooper receptacle 24 near the near end 20 of the handle 18.

FIG. 4 shows the scooper 4 of the animal waste scooper system 2 from the side. This is the second side 14. It is clear that this embodiment has an ergonomically curved handle 18. The handle 18 has the D handle 26 attached to the distal end 22 and the near end 20 inserts into the receptacle 24 near the near end of the handle 18 in the back of the scoop 4.

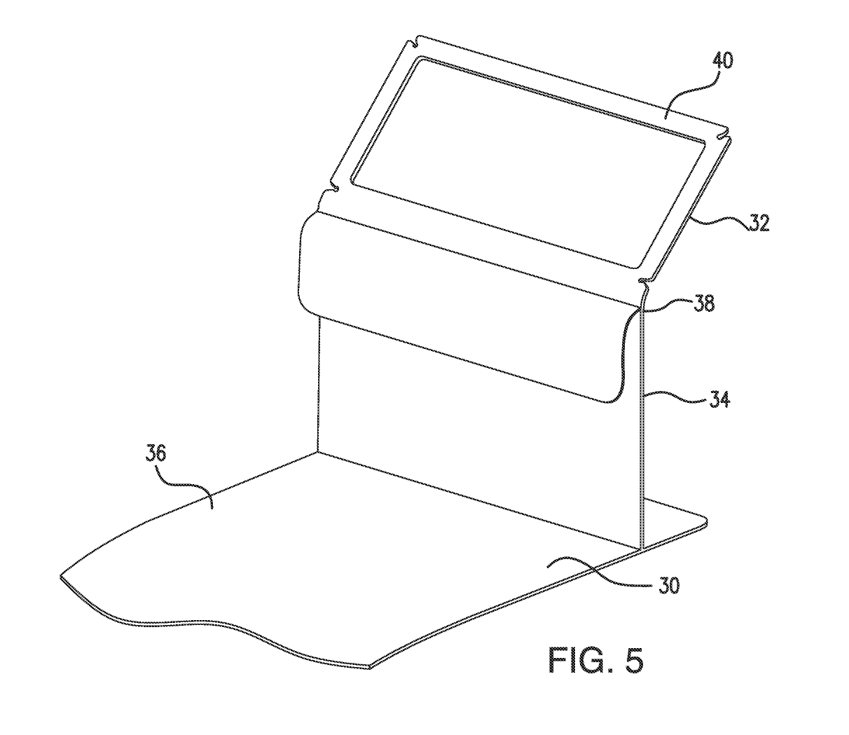

FIG. 5 shows the step mat 30 of the animal waste scooper system 2. The step mat 30 gives the animal waste scooper system 2 a greater utility over the prior art in, that it, allows the bagging frame 32 to remain in place when the litter is scooped from the litter box 28. It also retains the bags 42 at the end of the litter box 28 so the waste can be transferred directly into the bag 42 without any waste falling out. The top surface 36 of the step mat 30 is made of non-slip material continually holding the litter box 30, bag frame 32 and bags 42 in place.

There is a vertical wall 34 that extends from the top surface 36 of the step mat 30. This vertical wall 34 has a distal end 38 that supports the bagging frame 32 that hold the bags 4 for the collection of the animal waste.

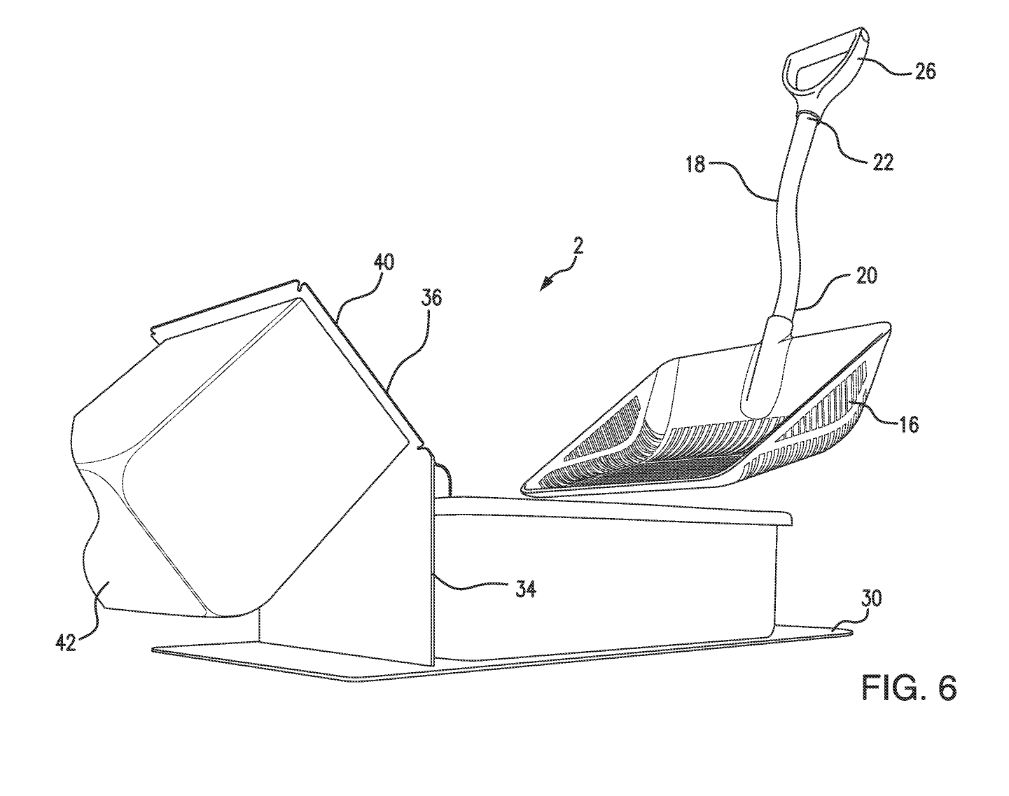

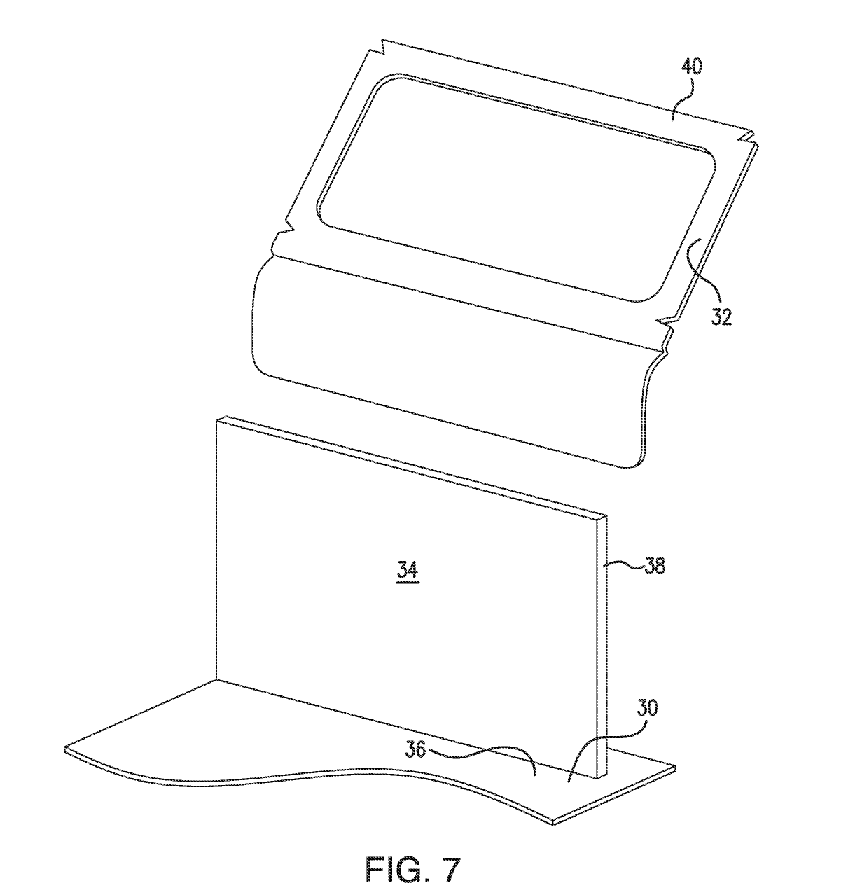

FIG. 6 shows the animal waste scooper system 2 from the side. This Figure shows the relationship between the basket like structure 6, the vertical wall 34 and the open frame 40. The user simply maneuvers the scoop through the basket like structure 6 and when the scoop 4 reaches the end of the basket like structure the animal waste is transferred directly into the bag 42.

FIG. 7 shows the vertical wall and the open frame 40 separated wherein it is shown the open frame 40, the vertical wall 34, and the distal edge 38. The separability of the vertical wall and the open frame are for the convenience of packaging for shipping, and storage.

What is claimed is:

1. An animal waste scooper system, said animal waste scooper system comprising in combination;
i. a scoop having a basket-like structure with a bottom, a back, having a receptacle formed therein, and two sides, each of said bottom, back, and sides having a plurality of apertures formed therethrough;
ii. a shaft, said shaft having a near end and a distal end, said near end insertable and fixed in said receptacle in said back, said distal end terminating in a handle grip;
iii. a litter box;
iv. a step mat;
v. integrally formed with said step mat, a frame bagging system comprising:
a. a vertical wall attached to a top surface of said step mat, said vertical wall having a distal end, said distal end comprised of
b. an open frame, said open frame fixed to said distal end of said vertical wall at a convenient angle.

2. The animal waste scooper system as claimed in claim 1 wherein, in addition, the frame bag holder and the vertical wall are separated.
